(19) United States
(12) Patent Application Publication
(10) Pub. No.: US 2021/0044875 A1
(43) Pub. Date: Feb. 11, 2021

(54) ELECTRONIC DEVICE AND CONTROL METHOD THEREFOR

(71) Applicant: SAMSUNG ELECTRONICS CO., LTD., Suwon-si (KR)

(72) Inventor: Kihyun LEE, Suwon-si (KR)

(73) Assignee: SAMSUNG ELECTRONICS CO., LTD., Suwon-si (KR)

(21) Appl. No.: 16/966,976

(22) PCT Filed: Jan. 3, 2019
(86) PCT No.: PCT/KR2019/000096

§ 371 Date: Aug. 3, 2020

(30) Foreign Application Priority Data
Apr. 11, 2018 (KR) 10-2018-0042365

(51) Int. Cl. H04N 21/8549; H04N 21/472; H04N 21/231; H04N 21/4545

(52) U.S. Cl. CPC H04N 21/8549; H04N 21/4545; H04N 21/23113; H04N 21/47217

(57) ABSTRACT

An electronic device is provided. The electronic device includes a storage in which a content is stored and a processor configured to obtain an audio signal from the content, identify a first section including a voice and a second section including background sound from the obtained audio signal, obtain at least one video frame from the content based on at least one of a type of emotion of the voice included in the first section and a type of atmosphere of the background sound included in the second section, and obtain summary content based on the obtained video frame.

### TECHNICAL FIELD

This disclosure relates to an electronic device and a control method therefor and more particularly, to an electronic device that generates summary content from content and a control method therefor.

### BACKGROUND ART

Conventionally, broadcast content has been watched mainly but recently, various VOD and streaming content services are increasingly provided through the Internet and mobile terminals. As the amount of content and viewing methods are diversified, users prefer to watch content according to individual interests and preferences, rather than watching content through the conventional method of receiving content unilaterally. To this end, a content summarization technology that can deliver information about content that users want to watch briefly and quickly is required.

In the past, there were a method in which content is summarized by a person directly and a method in which content is summarized automatically. In the former case, there was a disadvantage in that a lot of time and effort is needed since human intervention is required.

The method of automatically summarizing content includes the method of recognizing a main speaker using sound and content information, detecting the face of the speaker and summarizing content based on the character, and the method of summarizing content by extracting the narrative structure and the degree of development by unit with respect to the content having a story.

However, the former method has a problem in that it is difficult to deliver a story included in the content, and the latter method has a problem in that scenes that a user has interests and wants to watch may be excluded.

Accordingly, there is a need to develop a method that can not only generate summary content easily but also generate summary content including all important scenes.

### DETAILED DESCRIPTION OF INVENTION

### Technical Problem

The present disclosure relates to an electronic device for generating summary content including important scenes based on user preference and a control method therefor.

### Technical Solution

An electronic device according to an embodiment includes a storage in which a content is stored and a processor configured to obtain an audio signal from the content, identify a first section including a voice and a second section including background sound from the obtained audio signal, obtain at least one video frame from the content based on at least one of a type of emotion of the voice included in the first section and a type of atmosphere of the background sound included in the second section, and obtain summary content based on the obtained video frame.

The processor may be configured to obtain at least one first video frame from at least one first section from among a plurality of first sections based on a priority of an emotion type corresponding to each of the plurality of first sections, obtain at least one second video frame from at least one second section from among a plurality of second sections based on a priority of an atmosphere type corresponding to each of the plurality of second sections, obtain first summary content based on the at least one first video frame, and obtain second summary content based on the at least one second video frame.

The processor may be configured to, based on a playback time of the first summary content being less than a predetermined first time, filter the audio signal through a band-pass filter, and add a section of which size is greater than a predetermined first size in the band-pass filtered audio signal to the first summary content, and based on a playback time of the second summary content being less than a predetermined second time, filter the audio signal through a low-pass filter, and add a section of which size is greater than a predetermined second size in the low-pass filtered audio signal to the second summary content.

The predetermined first size may be calculated based on a difference between the predetermined first time and the playback time of the first summary content, and the predetermined second size may be calculated based on a difference between the predetermined second time and the playback time of the second summary content.

The device may further include a user interface, and the processor may be configured to receive information regarding a type and a playback time of the summary content through the user interface, and calculate the predetermined first time and the predetermined second time based on the received information.

The processor may be configured to, based on a playback time of the first summary content exceeding a predetermined first time, delete at least part of a plurality of first sections included in the first summary content based on a playback time of the plurality of first sections included in the first summary content.

The processor may be configured to, based on there being an overlapping portion between the first summary content and the second summary content, obtain the summary content based on a playback time of the overlapping portion and the deleted first section.

The processor may be configured to convert at least one of a channel or a sampling rate of the audio signal, and obtain the at least one video frame based on the converted audio signal.

The device may further include a display, and the processor may be configured to display the obtained summary content through the display.

According to an embodiment, a controlling method of an electronic device includes obtaining an audio signal from a content, identifying a first section including a voice and a second section including background sound from the obtained audio signal, obtaining at least one video frame from the content based on at least one of a type of emotion of the voice included in the first section and a type of atmosphere of the background sound included in the second section, and obtaining summary content based on the obtained video frame.

The obtaining at least one video frame may include obtaining at least one first video frame from at least one first section from among a plurality of first sections based on a priority of an emotion type corresponding to each of the plurality of first sections, and obtaining at least one second video frame from at least one second section from among a plurality of second sections based on a priority of an atmosphere type corresponding to each of the plurality of second sections, and the obtaining summary content may include obtaining first summary content based on the at least one first video frame, obtaining second summary content based on the at least one second video frame, and obtaining the summary content based on the first summary content and the second summary content.

The method may further include, based on a playback time of the first summary content being less than a predetermined first time, filtering the audio signal through a band-pass filter, and adding a section of which size is greater than a predetermined first size in the band-pass filtered audio signal to the first summary content, and based on a playback time of the second summary content being less than a predetermined second time, filtering the audio signal through a low-pass filter, and adding a section of which size is greater than a predetermined second size in the low-pass filtered audio signal to the second summary content.

The predetermined first size may be calculated based on a difference between the predetermined first time and the playback time of the first summary content, and the predetermined second size may be calculated based on a difference between the predetermined second time and the playback time of the second summary content.

The method may further include receiving information regarding a type and a playback time of the summary content, and calculating the predetermined first time and the predetermined second time based on the received information.

The method may further include, based on a playback time of the first summary content exceeding a predetermined first time, deleting at least part of a plurality of first sections included in the first summary content based on a playback time of the plurality of first sections included in the first summary content.

The obtaining summary content may include, based on there being an overlapping portion between the first summary content and the second summary content, obtaining the summary content based on a playback time of the overlapping portion and the deleted first section.

The obtaining an audio signal may include converting at least one of a channel or a sampling rate of the audio signal, and obtaining the at least one video frame based on the converted audio signal.

The method may further include displaying the obtained summary content.

According to an embodiment, in a non-transitory computer-readable recording medium in which a program to execute an operation method of an electronic apparatus is stored, the operation method includes obtaining an audio signal from a content, identifying a first section including a voice and a second section including background sound from the obtained audio signal, obtaining at least one video frame from the content based on at least one of a type of emotion of the voice included in the first section and a type of atmosphere of the background sound included in the second section, and obtaining summary content based on the obtained video frame.

### Effect of Invention

As the above-described various embodiments of the present disclosure, an electronic device may provide summary content including important scenes that reflect user preference by generating summary content based on a type of emotion of a voice and a type of atmosphere of background sound.

### DESCRIPTION OF DRAWINGS

FIG. 1A is a block diagram illustrating an example of configuration of an electronic device;

FIG. 1B is a block diagram illustrating an example of detailed configuration of an electronic device;

FIGS. 2A and 2B are views provided to explain an analysis of an audio signal according to various embodiments;

FIGS. 3A and 3B are views provided to explain a method of generating first summary content including a voice and second summary content including background sound according to an embodiment;

FIGS. 4A to 4C are views provided to explain a method of extending a playback time of second summary content according to an embodiment;

FIG. 5 is a view provided to explain a method of generating summary content according to an embodiment;

FIG. 6 is a view provided to explain a method of reducing a playback time of first summary content according to an embodiment;

FIG. 7 is a view provided to explain a method of changing an audio signal to improve a signal processing speed according to an embodiment;

FIGS. 8A and 8B are views provided to explain various embodiments;

FIG. 9 is a view provided to explain a method of generating summary content according to an extended embodiment;

FIG. 10 is a flowchart provided to explain a method of generating summary content according to an embodiment; and

FIG. 11 is a flowchart provided to explain a control method of an electronic device according to an embodiment.

### BEST MODE

### Detailed Description of Exemplary Embodiments

Hereinafter, various embodiments of the present disclosure will be described in detail using accompanying drawings.

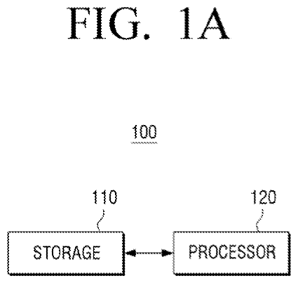

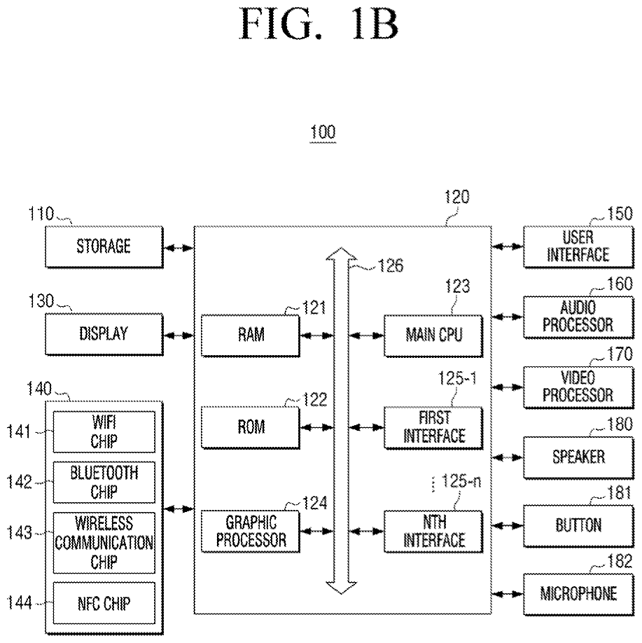

FIG. 1A is a block diagram illustrating an example of configuration of an electronic device 100.

The electronic device 100 may be a device that generates summary content. For example, the electronic device 100 may generate 10 minutes of summary content including a main scene from 120 minutes of content.

The electronic device 100 may be a set-top box (STB), a desktop PC, a notebook PC, a smartphone, a tablet PC, a server, a TV, etc. However, the electronic device 100 is not limited thereto, and the electronic device 100 may be any device capable of generating summary content from content.

Referring to FIG. 1A, the electronic device 100 includes a storage 110 and a processor 120.

The storage 110 may store content. For example, the electronic device 100 may receive content from an external device, and store the received content in the storage 110. Alternatively, the electronic device 100 may generate content directly through a camera, etc., and store the generated content in the storage 110.

The storage 110 may be implemented as a hard disk, a non-volatile memory, a volatile memory, etc., and may be any configuration capable of storing data.

The processor 120 controls the overall operations of the electronic device 100.

According to an embodiment, the processor 120 may be implemented as a digital signal processor (DSP), a microprocessor, or a time controller (T-CON) processing a digital video signal. However, the processor 120 is not limited thereto, but may include one or more of a central processing unit (CPU), a micro controller unit (MCU), a micro processing unit (MPU), a controller, an application processor (AP), a communication processor (CP), or an ARM processor, or may be defined by the corresponding term. In addition, the processor 120 may be implemented by a system-on-chip (SoC) or a large scale integration (LSI) in which a processing algorithm is embedded or may be implemented in the form of a field programmable gate array (FPGA).

The processor 120 may obtain an audio signal in content, and identify a first section including a voice in the obtained audio signal and a second section including a background sound. For example, the processor 120 may identify, from a 10 minutes of an audio signal, the section of 1 minute˜7 minute as the first section including a voice, the section of 7 minute˜9 minute as the second section including background sound, and the section of 9 minute˜10 minute as the first section including a voice. Here, the audio signal may include a plurality of first sections and a plurality of second sections. In addition, the audio signal may further include a mute section.

The processor 120 may obtain at least one video frame in the content based on at least one of a type of emotion of the voice included in the first section and a type of atmosphere of background sound included in the second section, and obtain summary content based on the obtained video frame.

In the above example, the processor 120 may identify the section of 0 minute 7 minute as “surprised”, the section of 7 minute˜9 minute “urgent”, and the section of 9 minute˜10 minute as “neutral.” In addition, the processor 120 may obtain a video frame corresponding to the section of which emotion type is “surprised” and the section of which atmosphere type is “urgent”, and obtain summary content based on the obtained video frame.

Here, the emotion type may include at least one of angry, neutral, surprised, or sad, and the atmosphere type may include at least one of angry, urgent, surprised, or sad, but are not limited thereto. The emotion type and the atmosphere type may include any other types.

The processor 120 may obtain at least one first video frame in at least one first section from among the plurality of first sections based on a priority of an emotion type corresponding to each of the plurality of first sections, obtain at least one second video frame in at least one second section from among the plurality of second sections based on a priority of an atmosphere type corresponding to each of the plurality of second sections, obtain first summary content based on the at least one first video frame, and obtain second summary content based on the at least one second video frame.

For example, if the priority of “surprised” is higher between the first section identified as “surprised” and the first section identified as “sad”, the processor 120 may obtain the first video frame in the first section identified as “surprised.” If the priority of “urgent” is higher between the second section identified as “urgent” and the second section identified as “surprised”, the processor 120 may obtain the second video frame in the second section identified as “urgent.”

Here, the priority of the emotion type and the priority of the atmosphere type may be determined according to the type of content. For example, if content is an action movie, the priority of the emotion type is set such that the first priority is “surprised” and the subsequent priorities are “angry”, “neutral” and “sad, the priority of the atmosphere type is set such that the first priority is “urgent” and the subsequent priorities are “surprised”, “angry” and “sad.” The processor 120 may identify the type of content, and determine the priority of the emotion type and the priority of the atmosphere type according to the identified type of content.

Subsequently, the processor 120 may obtain the first summary content using the first video frame, obtain the second summary content using the second video frame, and generate summary content based on the first summary content and the second summary content.

If the playback time of the first summary content is less than a predetermined first time, the processor 120 may filter the audio signal through a band-pass filter, and add a section that is equal to or greater than a predetermined first size in the band-pass filtered audio signal to the first summary content. When the audio signal is band-pass filtered, a voice can be emphasized.

If the playback time of the second summary content is less than a predetermined second time, the processor 120 may filter the audio signal through a low-pass filter, and add a section that is equal to or greater than a predetermined second size in the low-pass filtered audio signal to the second summary content. When the audio signal is low-pass filtered, background sound can be emphasized.

Here, the predetermined first size may be calculated based on a different between the predetermined first time and the playback time of the first summary content, and the predetermined second size may be calculated based on a difference between the predetermined second time and the playback time of the second summary content.

In other words, the processor 120 may determine the predetermined first size such that the playback time of the first summary content becomes the predetermined first time. As the predetermined first size increases, a section added to the first summary content may become shorter, and as the predetermined first size decreases, a section added to the first summary content may become longer.

In addition, the processor 120 may determine the predetermined second size such that the playback time of the second summary content becomes the predetermined second time. As the predetermined second size increases, a section added to the second summary content may become shorter, and as the predetermined second size decreases, a section added to the second summary content may become longer.

Meanwhile, the electronic device 100 may further include a user interface, and the processor 120 may receive information regarding a type and a playback time of summary content through the user interface and calculate a predetermined first length and a predetermined second length based on the received information.

The type of summary content may be one of a dialog type or a highlight type. For example, if information regarding 10 minutes of playback time is received and a dialog type is selected, the processor 120 may configure 7 minutes out of 10 minutes with the first summary content and configure 3 minutes out of 10 minutes with the second summary content. In other words, the processor 120 may add a part of sections of the band-pass filtered audio signal to the first summary content so that the first summary content takes up 7 minutes, and add a part of sections of the low-pass filtered audio signal to the second summary content so that the second summary content takes up 3 minutes.

However, the present disclosure is not limited thereto, and when information regarding 10 minutes of playback time is received and a dialog type is selected, the processor 120 may configure 9 minutes out of 10 minutes with the first summary content and 1 minute out of 10 minutes with the second summary content. Alternatively, if information regarding 10 minutes of playback time is received and a dialog type is selected, the processor 120 may configure the entire 10 minutes with the first summary content.

The processor 120 may receive the type of summary content through a user interface, receive a weighted value of a dialog type or a highlight, and calculate a predetermined first length and a predetermined second length based on the received information.

For example, if information regarding 10 minutes of playback time is received and 0.6 is input as the weighted value of a dialog type, the processor 120 may configure 6 minutes out of 10 minutes with the first summary content and configure 4 minutes out of 10 minutes with the second summary content.

Alternatively, the processor 120 may receive information regarding the type of and playback time of summary content through a microphone, and calculate a predetermined first length and a predetermined second length based on the received information.

In this case, the processor 120 may digitize an analog voice signal received from the microphone, and identify information regarding the type and playback time of summary content by performing text conversion. In other words, the electronic device 100 may further include a microphone, a user voice may be received by the microphone and converted into an analog voice signal, and the analog voice signal may be transmitted from the microphone to the processor 120.

Alternatively, information regarding the type and playback time of summary content may be input from an external device, and the electronic device 100 may perform communication with the external device and receive information regarding the type and playback time of summary content. For example, the electronic device may be a remote controller, and a user may input information regarding the type and playback time of summary content through the remote controller. In this case, the information may be input through a button or using a user voice. The remote controller may transmit the input information to the electronic device 100.

When the remote controller receives a user voice, the remote controller may include a microphone. The remote controller may transmit the user voice to the electronic device 100 as an analog signal without processing. In this case, the electronic device 100 may digitize the received analog signal, and perform text conversion with respect to the digitized user voice to perform a corresponding operation.

In addition, the remote controller may convert the user voice from an analog signal to a digital signal, and transmit the digital signal to the electronic device 100. In this case, the electronic device 100 may perform text conversion with respect to the digitized user voice and perform a corresponding operation.

Further, the remote controller may convert the user voice into a text, and transmit the text information to the electronic device 100. In this case, a received signal may be used without a particular conversion operation of the electronic device 100.

The electronic device 100 may include a communicator to receive a user voice from a remote controller. For example, the electronic device 100 may receive a user voice from the remote controller using Bluetooth or WiFi, and the electronic device 100 may include at least one of a Bluetooth module or a WiFi module.

However, the present disclosure is not limited thereto, and any standard that enables data communication with a remote controller may be used. In addition, the electronic device 100 may include a plurality of communication modules for communication with a server which will be described later. For example, the electronic device 100 may include an Ethernet modem and a Bluetooth module, perform communication with a server through the Ethernet modem, and perform communication with a remote controller through the Bluetooth module. Alternatively, the electronic device 100 may include a plurality of WiFi modules, perform communication with a server through a first WiFi module, and perform communication with a remote controller through a second WiFi module. In other words, the electronic device 100 may include a plurality of homogeneous communication modules, and include a plurality of heterogeneous communication modules. The electronic device 100 may include not only a plurality of homogeneous communication modules but also a plurality of heterogeneous communication modules.

Meanwhile, the remote controller may be a device manufactured exclusively to perform communication with the electronic device 100, but is not limited thereto. For example, an application to perform communication with the electronic device 100 may be installed in a smartphone and it can be used as a remote controller. In this case, the smartphone may receive a user voice while the application is being executed, and transmit the input user voice to the electronic device 100.

Meanwhile, the digitization of a user voice and text conversion may be performed in a separate server. For example, the electronic device 100 may transmit a user voice received through a microphone or a user voice received from a remote controller to a server without a separate conversion process, and receive text information corresponding to the user voice from the server. The electronic device 100 may calculate a predetermined first length and a predetermined second length based on the text information.

The electronic device 100 may perform communication with a plurality of servers. For example, the electronic device 100 may transmit a user voice received through a microphone and a user voice received from a remote controller to a first server without a separate conversion process, and receive text information corresponding to the user voice from the first server. Subsequently, the electronic device 100 may transmit the text information corresponding to the user voice to a second server, and receive a predetermined first length and a predetermined second length that are calculated based on the text information from the second server.

Meanwhile, if the playback time of the first summary content exceeds the predetermined first length, the processor 120 may delete a part of the plurality of first sections included in the first summary content based on the playback time of the plurality of first sections included in the first summary content.

For example, if the playback time of the first summary content is 15 minutes and the predetermined first time is 10 minutes, the processor 120 may shorten the playback time of the first summary content to 10 minutes by deleting a part of the plurality of first sections included in the first summary content in the order of shortest playback time from among the plurality of first sections included in the first summary content.

For example, if the first summary content includes 5 minutes of “sad” section, 5 minutes of “angry” section, 3 minutes of “neutral” section, and 2 minutes of “surprised” section, the processor 120 may make the first summary content to last for ten minutes by deleting the 3 minutes of “neutral” section and 2 minutes of “surprised” section that have the short playback times.

If the playback time of the first summary content exceeds the predetermined first time, the processor 120 may delete at least a part of the plurality of first sections included in the first summary content based on at least one of the playback time or emotion type of the plurality of first sections included in the first summary content.

For example, if the first summary content includes 5 minutes of “sad” section, 5 minutes of “angry” section, 3 minutes of “neutral” section, and 2 minutes of “surprised” section, the processor 120 may make the first summary content to last for 10 minutes by deleting the 5 minutes of “sad” section which has a low priority among the types of emotion. If there are a plurality of sections having the same emotion type, the processor 120 may delete some sections based on the playback time.

The above-mentioned deleting operation may be applied to the second summary content in the same manner. In other words, if the playback time of the second summary content exceeds the predetermined second time, the processor 120 may delete at least part of the plurality of second sections included in the second summary content based on at least one of the playback time or atmosphere type of the plurality of second sections included in the second summary content.

Meanwhile, if there is an overlapping portion between the first summary content and the second summary content, the processor 120 may obtain a summary content based on the playback time of the overlapping portion and the deleted first section.

If content is 120 minutes long, the first summary content is the content of 20 minutes to 27 minutes, and the second summary content is the content of 25 minutes to 30 minutes, the processor 120 may generate summary content by incorporating the first summary content and the second summary content. In this case, the overlapping portion does not need to be played twice, the processor 120 may delete one of the section of 25 minutes to 27 minutes of the first summary content or the section of 25 minutes to 27 minutes of the second summary content.

In this case, the final summary content generated is shorted by the overlapped portion and thus, it may be shorter than the sum of the predetermined first time and the predetermined second time. Accordingly, the processor 120 may extend the playback time of the summary content by adding some of the first section that has been deleted to correspond to the playback time of the overlapping portion.

However, the present disclosure is not limited thereto, and the processor 120 may add some of the deleted second section.

Meanwhile, the processor 120 may convert at least one of the channel or sampling rate of an audio signal, and obtain at least one video frame based on the converted audio signal.

For example, the processor 120 may convert a stereo audio signal to a mono audio signal, and lower the sampling rate of the converted mono audio signal. Subsequently, the processor 120 may identify the first section including a voice and the second section including background sound in the mono audio signal of which sampling rate has been lowered, obtain at least one video frame in the content based on at least one of the type of emotion of the voice included in the first section and the type of atmosphere included in the second section, and obtain summary content based on the obtained video frame. Through such an operation, an operation speed can be enhanced.

Meanwhile, the electronic device 100 may further include a display, and the processor 120 may display the obtained summary content through the display. The processor 120 may store the obtained summary content in the storage 110.

Through the above-described method, the processor 120 may generate summary content.

FIG. 1B is a block diagram illustrating an example of detailed configuration of the electronic device 100. The electronic device 100 may include the storage 100 and the processor 120. In addition, referring to FIG. 1B, the electronic device 100 may further include a display 130, a communicator 140, a user interface 150, an audio processor 160, a video processor 170, a speaker 180, a button 181, and a microphone 182. Among the components illustrated in FIG. 1B, detailed descriptions of the components overlapping with those illustrated in FIG. 1A will be omitted.

The processor 120 controls the overall operations of the electronic device 100 using various programs stored in the storage 110.

Specifically, the processor 120 may include a RAM 121, a ROM 122, a main CPU 123, a graphic processor 124, first to n-th interfaces 125-1 to 125-n, and a bus 126.

Here, the RAM 121, the ROM 122, the main CPU 123, the graphic processor 124, and the first to n-th interfaces 125-1 to 125-n may be connected to one another through the bus 126.

The first to n-th interfaces 125-1 to 125-n are connected to various components described above. One of the interfaces may be a network interface connected to an external device through the network.

The main CPU 123 accesses the storage 110, and performs booting by using the O/S stored in the storage 110. Further, the main CPU 123 performs various operations by using various programs stored in the storage 110.

The ROM 122 stores a set of instructions for system booting, and the like. Once a turn-on command is input and power is supplied, the main CPU 123 copies the O/S stored in the storage 110 to the RAM 121 according to an instruction stored in the ROM 122, and executes the O/S to boot the system. Once the booting is completed, the main CPU 123 copies various application programs stored in the storage 110 to the RAM 121, and executes the application programs copied to the RAM 121 to perform various operations.

The graphic processor 124 generates a screen including various objects such as an icon, an image, and a text by using a calculator (not illustrated) and a renderer (not illustrated). Here, the calculator (not illustrated) may be a component that calculates an attribute value such as a coordinate value, a shape, a size, or a color in which each object to be displayed according to a layout of the screen by using a received control command. Further, the renderer (not illustrated) may be a component that generates a screen with various layouts including an object based on the attribute value calculated by the calculator (not illustrated). The screen generated by the renderer (not illustrated) may be displayed within a display region of the display 130.

Meanwhile, the operations of the above-described processor 120 may be performed by the programs stored in the storage 110.

The storage 110 store various data such as an operating system (O/S) software module to drive the electronic device 100, an audio signal analysis module, a video frame editing module, etc.

The display 130 may be implemented as various types of displays such as Liquid Crystal Display (LCD), Organic Light Emitting Diodes (OLED) display, Plasma Display Panel (PDP), etc. A driving unit that can be implemented in the form of a-si TFT, low temperature poly silicon (LTPS) TFT, organic TFT (OTFT), etc., a backlight unit, etc. may also be included in the display 130. Meanwhile, the display 130 may be implemented as a touch screen in combination with a touch sensor.

The communicator 140 is configured to perform communication with various types of external devices according to various types of communication methods. The communicator 140 includes a WiFi chip 141, a Bluetooth chip 142, a wireless communication chip 143, an NFC chip 144, etc. The processor 120 performs communication with various external devices using the communicator 140.

The Wi-Fi chip 141 and the Bluetooth chip 142 performs communication by a Wi-Fi method and a Bluetooth method, respectively. In case of using the Wi-Fi chip 141 or the Bluetooth chip 142, various connection information such as a service set identifier (SSID) and a session key may be first transmitted and received to establish communication connection, and then various information may be transmitted and received. The wireless communication chip 143 refers to a chip performing communication according to various communication protocols such as IEEE, Zigbee, 3rd generation (3G), 3rd generation partnership project (3GPP), and long term evolution (LTE). The NFC chip 144 refers to a chip operated by a Near Field Communication (NFC) method using a frequency band of 13.56 MHz among various RF-ID frequency bands such as 135 kHz, 13.56 MHz, 433 MHz, 860 to 960 MHz, and 2.45 GHz.

In addition, the communicator 140 may further include a wired communication interface such as HDMI, MHL, USB, DP, thunderbolt, RGB, D-SUB, and DVI. The processor 120 may be connected to a display device through the wired communication interface. In this case, the processor 120 may transmit summary content obtained through the wired communication interface to a display device.

The user interface 150 receive various user interactions. Here, the user interface 150 can be implemented in various forms according to an implementation example of the electronic device 100. For example, the user interface 150 may be a button provided in the electronic device 100, a microphone receiving a user voice, a camera sensing a user motion, etc. Alternatively, when the electronic device 100 is implemented as a touch-based terminal device, the user interface 150 may be implemented in the form of a touch screen that forms an interlayered structure with respect to a touch pad. In this case, the user interface 150 can be used as the above-described display 130.

The audio processor 160 is configured to process audio data. The audio processor 160 may perform various processing such as decoding, amplification, noise filtering, etc. with respect to audio data.

The video processor 170 is configured to process video data. The video processor 170 may perform various processing such as decoding, scaling, noise filtering, frame rate conversion, resolution conversion, etc. with respect to video data.

The speaker 180 is configured to output not only various audio data processed by the audio processor 160 but also various alarm sound, voice messages, etc.

The button 181 may be various types of buttons such as a mechanical button, a touch pad, and a wheel formed in any region such as a front surface portion, a side surface portion, or a rear surface portion of a body appearance of the electronic device 100.

The microphone 182 is configured to receive a user voice or other sound and convert the same into audio data.

Through the above-described method, the processor 120 may generate summary content from content automatically based on a type of emotion of a voice and a type of atmosphere of background sound.

Hereinafter, the operations of the electronic device 100 will be described in detail with reference to accompanying drawings.

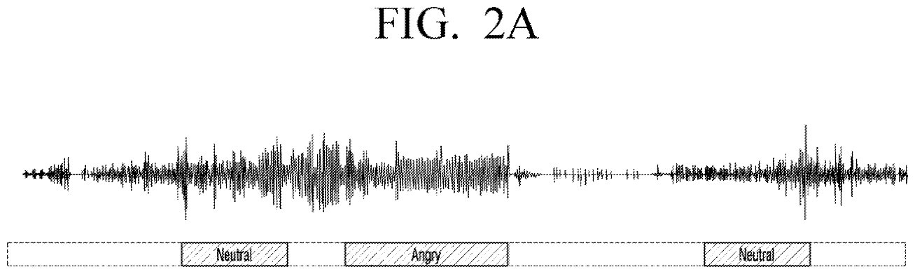

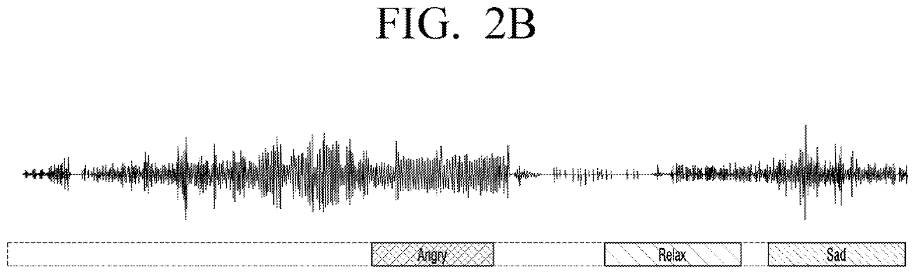

FIGS. 2A and 2B are views provided to explain an analysis of an audio signal according to various embodiments of the present disclosure.

The processor 120 may analyze an audio signal based on the size, frequency, timbre, tone, etc. For example, the processor 120 may identify a portion in which loud sound composed of low-frequency components appears periodically in the audio signal, and generate summary content using a corresponding video frame. Here, the portion in which loud sound composed of low-frequency components appears periodically is grand sound, and may be an action scene.

The processor 120 may identify a section including a voice in the audio signal, and identify a type of emotion of the section including the voice. For example, as illustrated in FIG. 2A, the processor 120 may identify “neutral” section, “angry” section and “neutral” section in the audio signal. Here, the x-axis represents time, and the remaining sections may be sections that do not include a voice. In other words, the processor 120 may identify the playback start time point, the playback end time point and the type of emotion of a certain section in the entire audio signal.

In addition, the processor 120 may identify a section including background sound in the audio signal, and identify the type of atmosphere of the section including the background sound. For example, as illustrated in FIG. 2B, the processor 120 may identify “angry” section, “relax” section and “sad” section. Here, the x-axis represents time, and the remaining sections may be sections that do not include background sound. In other words, the processor 120 may identify the playback start time point, the playback end time point, and the type of atmosphere of a certain section in the entire audio signal.

In FIGS. 2A and 2B, it is described that a section including a voice or background sound is identified first and then, the type of emotion of the voice or the type of atmosphere of the background sound is identified, but the present disclosure is not limited thereto. For example, the processor 120 may identify the type of emotion of the voice or the type of atmosphere of the background sound directly from the audio signal.

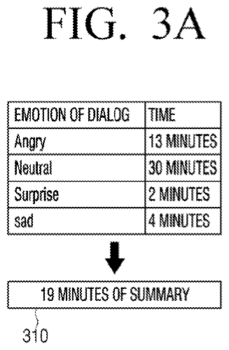

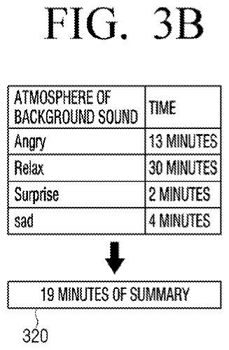

FIGS. 3A and 3B are views provided to explain a method of generating first summary content including a voice and second summary content including background sound according to an embodiment.

As illustrated in FIG. 3A, the processor 120 may obtain the total time of the section identified as “angry” in an audio signal. Here, the section identified as “angry” may be one and in this case, the one section may be 13 minutes. Alternatively, there may be a plurality of sections identified as “angry” and in this case, the processor 120 may calculate 13 minutes by summing the times of the plurality of sections identified as “angry.” The processor 120 may obtain the total time for each type of emotion through the same method for the remaining types of emotion.

The processor 120 may generate the first summary content based on the priority of emotion type of a voice. For example, as illustrated in FIG. 3A, the processor 120 may generate the first summary content 310 of 19 minutes using a video frame corresponding to the section identified as “angry”, the section identified as “surprised” and the section identified as “sad.” However, the present disclosure is not limited thereto, and priorities may vary.

In addition, the processor 120 may generate the first summary content by further considering the predetermined first time. For example, if the predetermined first time is 15 minutes, the processor 120 may generate the first summary content having 15 minutes of playback time using a video frame corresponding to the section identified as “angry” and the section identified as “surprised.”

If there is an overlapping portion from among a plurality of sections, the first summary content may become shorter than the predetermined first time. In this case, the processor 120 may add a part of the remaining sections that are not included in the first summary content to the first summary content based on at least one of the priority and the predetermined first time.

If the difference between the playback time of the first summary content and the predetermined first time is within a predetermined difference, the processor 120 may stop generating the first summary content.

However, the present disclosure is not limited thereto, and the processor 120 may delete or add some frames so that the playback time of the first summary content becomes the predetermined first time.

Meanwhile, as illustrated in FIG. 3B, the processor 120 may generate second summary content based on the priority of the type of atmosphere of background sound. For example, as illustrated in FIG. 3B, the processor 120 may generate second summary content 320 of 19 minutes using a video frame corresponding to the section identified as “angry”, the section identified as “surprised” and the section identified as “sad.”

The method of generating the second summary content in FIG. 3B is the same as the method of generating the first summary content in FIG. 3A and thus, specific description thereof will be omitted.

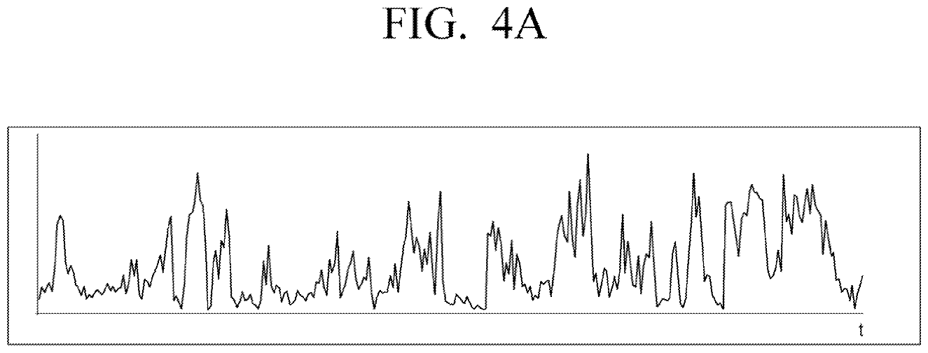

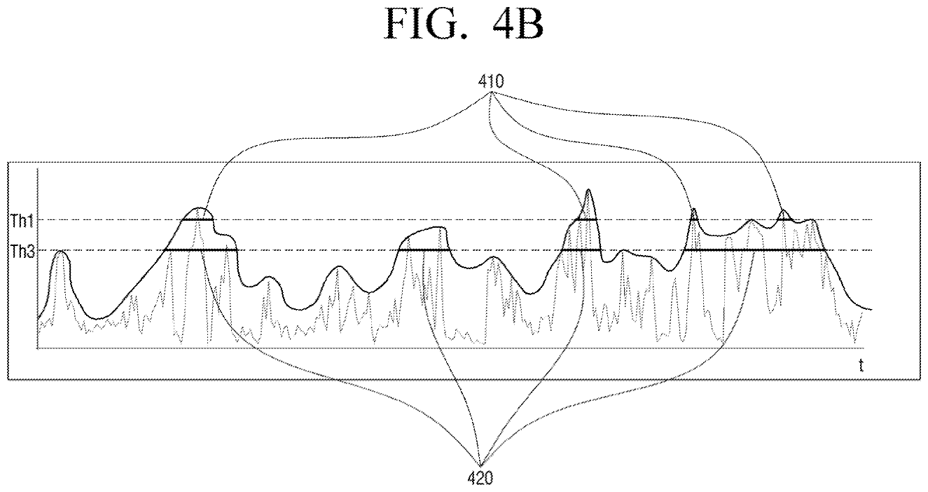

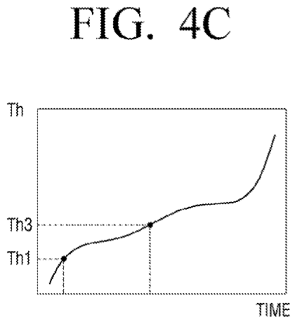

FIGS. 4A to 4C are views provided to explain the method of extending the playback time of the second summary content according to an embodiment.

FIG. 4A is a view illustrating an example of the size of an audio signal along a time axis. In general, as an audio signal progresses to a climax, the size increases continuously, and a portion of the audio signal that periodically decreases in size may be a dialog section.

As illustrated in FIG. 4B, the processor 120 may low-pass filter an audio signal of FIG. 4A. In FIG. 4B, the low-pass filtered audio signal is a signal in which high-frequency components are removed from the audio signal of FIG. 4A, and may be roughly illustrated as an outline of the audio signal in FIG. 4A. The low-pass filtered audio signal may include beats such as drum sound, and may be explosive sound, background sound with sense of tension.

The processor 120 may add a first additional section 410 that is greater than Th1 in the low-pass filtered audio signal to the second summary content or add a third additional section 420 that is greater than Th3 to the second summary section. Here, since Th1 is greater than Th3, the first additional section 410 may be shorter than the third additional section 420. In other words, the processor 120 may change the time of the section to be added to the second summary content by changing a reference size such as Th1 or Th3.

In FIG. 4B, only Th1 and Th3 are illustrated for convenience of explanation, but as illustrated in FIG. 4C, the processor 120 may calculate time information of an added section according to a reference size such as Th1 or Th3.

The processor 120 may calculate time to be added by comparing the playback time of the second summary content and the predetermined second time. For example, if the predetermined second time is 2 hours and 20 minutes and the playback time of the second summary content is 15 minutes, the processor 120 may obtain a Th value in the database as shown in FIG. 4C, and add a section having a size greater than the TH value obtained in the database as shown in FIG. 4B to the second summary content. Through such a method, the processor 120 may generate the second summary content having the playback time desired by a user.

Meanwhile, the method of extending the playback time of the first summary content uses a band-pass filter instead of a low-pass filter in the method of extending the playback time of the second summary content, and the frequency to be band-passed may correspond to a voice band of a person. For example, a band-pass filter of 300 Hz to 4 Khz may be used, and a section having a large size in the band-pass filtered audio signal may be a part where emotion is generally intense. Since other operations are the same, overlapping description will be omitted.

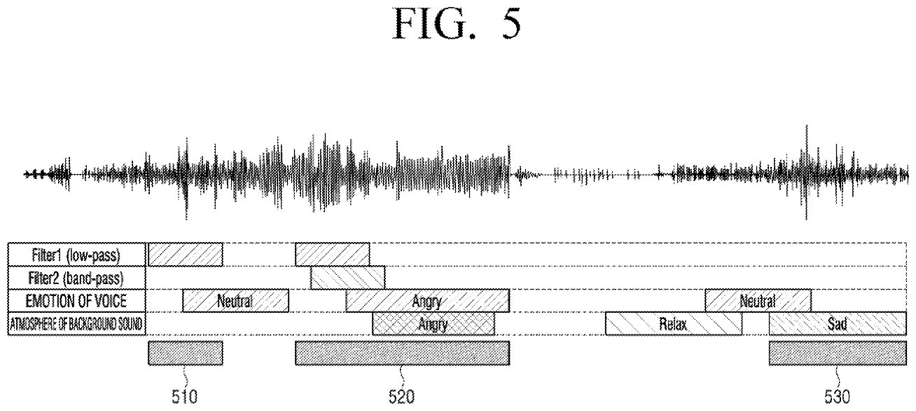

FIG. 5 is a view provided to explain the method of generating summary content according to an embodiment.

As illustrated in FIG. 5, the processor 120 may generate summary contents 510, 520, 530 based on the section identified according to the type of dialog emotion in an audio signal, the section identified according to the type of atmosphere of background sound, the section that is equal to or greater than the predetermined first size in the low-pass filtered audio signal, and the section that is equal to or greater than the predetermined second size in the band-pass filtered audio signal.

Here, the processor 120 may generate summary content such that an overlapping portion is reproduced only once. In addition, the processor may not add to the summary content the sections identified as “neutral” in the voice and the sections identified as “relax” in the background sound. The sections identified as “neutral” in the voice and the sections identified as “relax” in the background sound may be sections having a relatively low impact.

However, among the sections identified as “neutral” in the voice and the sections identified as “relax” in the background sound, sections overlapping with important sections may be added to the summary content. For example, as illustrated in FIG. 5, part of the section identified as “neutral” overlaps with part of the section of the background sound identified as “sad”, and since the section identified as “sad” is an important section, the processor 120 may add the part of the section identified as “sad” that is overlapped with the section identified as “neutral” to the summary content.

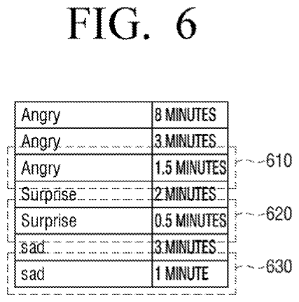

FIG. 6 is a view provided to explain a method of reducing a playback time of first summary content according to an embodiment.

If the playback time of the first summary content exceeds a predetermined first time, the processor 120 may delete at least a part of a plurality of first sections included in the first summary content based on the playback time of the plurality of first sections included in the first summary content.

For example, as illustrated in FIG. 6, the first summary content having a total playback time of 19 minutes may include three sections identified as “angry”, two sections identified as “surprised”, and two sections identified as “sad.”

If the predetermined first time is 17.5 minutes, the processor 120 may delete a section 610 identified as “angry” of 1.5 minutes from the summary content in order to reduce 1.5 minutes.

Alternatively, if the predetermined first time is 17.5 minutes, the processor 120 may delete a section 620 identified as “surprised” of 0.5 minutes and a section 630 identified as “sad” from the first summary content in the order of the shortest length of the sections in order to reduce 1.5 minutes.

The method of deleting second summary content is the same as the method of deleting the first summary content and thus, specific description thereof will be omitted.

Meanwhile, if there is an overlapping portion between the first summary content and the second summary content, the processor 120 may obtain summary content based on the playback time of the overlapping portion and the deleted first section.

In the above example, the processor 120 may add at least one of the section 610 identified as “sad” of 1.5 minutes, the section 620 identified as “surprised” of 0.5 minutes or the section 630 identified as “sad” of 1 minute which is deleted to the summary content in order to extend the playback time of the summary content as much as the playback time of the overlapping portion.

However, the present disclosure is not limited thereto, and the processor 120 may add the section deleted from the second summary content, to the summary content.

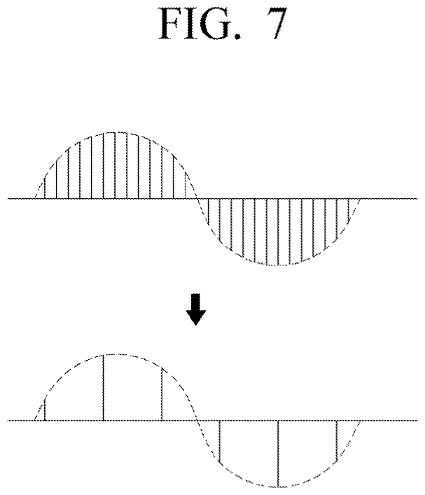

FIG. 7 is a view provided to explain a method of changing an audio signal to improve a signal processing speed according to an embodiment.

Firstly, the processor 120 may lower a channel of an audio signal. For example, the processor 120 may convert a stereo audio signal to a mono audio signal.

In addition, the processor 120 may lower a sample rate of an audio signal as illustrated in FIG. 7. Accordingly, an operation speed may be improved.

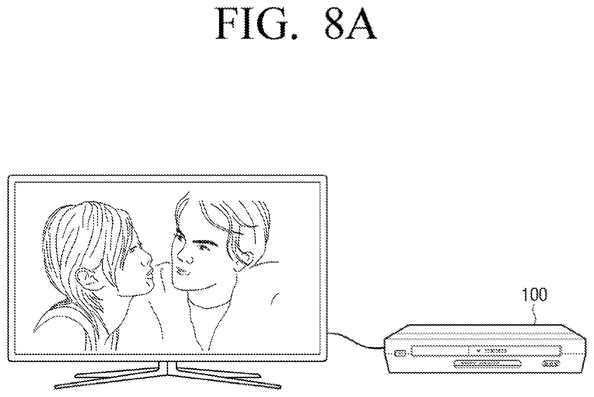

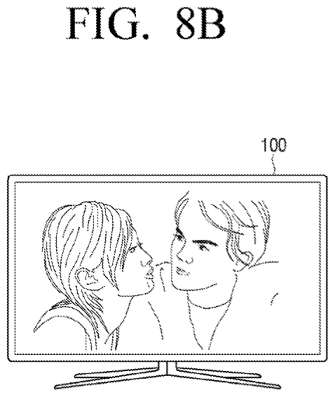

FIGS. 8A and 8B are views provided to explain various embodiments.

As illustrated in FIG. 8A, the electronic device 100 may be a device that provides summary content to an external display device without a display. For example, the electronic device 100 may be a device such as a set-top box (STB), a desktop PC, etc.

In this case, the electronic device 100 may transmit summary content to an external display device, and may transmit a command to reproduce the summary content in the external display device additionally.

The electronic device 100 may include a wired communication interface such as HDMI, MHL, USB, DP, thunderbolt, RGB, D-SUB, DVI, etc. to transmit summary content to an external display device. In this case, the electronic device 100 may transmit the summary content to the external display device through one wired communication interface. Alternatively, the electronic device 100 may transmit the video data and the audio data of the summary content to the external display device through different wired communication interfaces. The electronic device 100 may transmit one of the video data or the audio data of the summary content to the external display device through a wired communication interface, and transmit the other one of the video data or the audio data of the summary content to the external display device through a wireless communicator.

As illustrated in FIG. 8B, the electronic device 100 may be a display device. In this case, the electronic device 100 may include a display, and control the display to display obtained summary content.

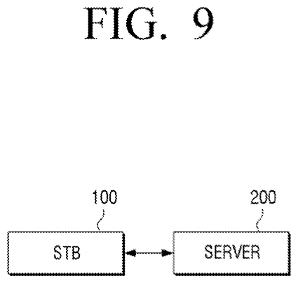

FIG. 9 is a view provided to explain a method of generating summary content according to an extended embodiment.

As illustrated in FIG. 9, a summary content generating system may include a set-top box (STB) 100 and a server 200.

The set-top box 100 may receive a command to generate summary content from a user. In this case, the command to generate summary content may further include information regarding the title of the content, the type of the summary content and the playback time.

The server 200 may store a plurality of contents, and receive a command to generate summary content from the set-top box 100. The server 200 may generate summary content regarding one of the plurality of contents based on the command to generate summary content received from the server. The specific method of generating summary content is the same as the method described with reference to FIGS. 1A to 7 and this, it will be omitted.

In addition, the set-top box 100 may transmit a command to generate summary content and content to the server 200. In this case, the server 200 may generate summary content regarding the received content based on the received command to generate summary content.

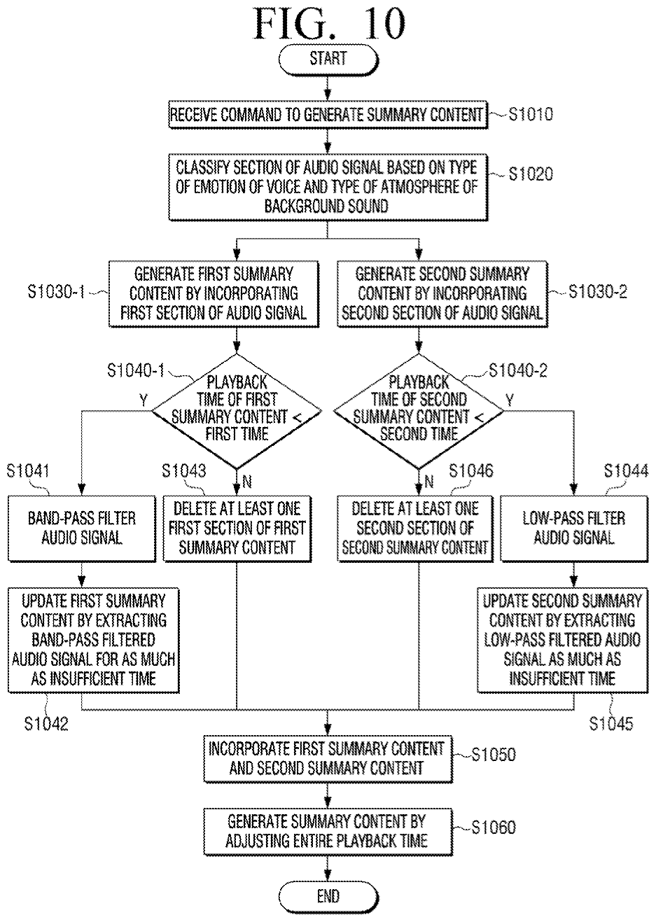

FIG. 10 is a flowchart provided to explain a method of generating summary content according to an embodiment.

Firstly, the processor 120 may receive a command to generate summary content (S1010). For example, the processor 120 may receive a command to receive summary content through a button 181 or a microphone 182 provided in the electronic device 100. Alternatively, the processor 120 may receive a command to receive summary content from a remote controller. In this case, the remote controller may transmit the command to receive summary content received from a user to the electronic device 100.

The command to generate summary content may further include information regarding content, the type of summary content and the playback time. For example, the command to generate summary content may be a command to generate summary content which include 90% of highlight with respect to an image that is being reproduced and the playback time is 10 minutes. In this case, the processor 120 may generate summary content that ultimately includes 9 minutes of highlight and 1 minute of dialog. The processor 120 may include the section including background sound as a highlight section.

When the command to generate summary content is received, the processor 120 may classify the sections of an audio signal based on the type of emotion of a voice and the type of atmosphere of background sound (S1020). For example, the processor 120 may identify the section of 1 minute to 2 minutes and 20 seconds of the audio signal with a total playback time of 10 minutes as “surprised” in the voice, and identify the section of 5 minutes to 7 minutes as “neutral” in the voice. In addition, the processor 120 may identify the section of 2 minutes to 5 minutes of the audio signal with a total playback time of 10 minutes as “urgent” in the atmosphere, and identify the section of 9 minutes to 10 minutes as “sad” in the atmosphere.

Here, the audio signal may be an audio signal included in the content. In other words, the processor 120 may extract an audio signal from the content, and classify the sections of the audio signal. In addition, the processor 120 may reduce the channel and bit rate of the audio signal to improve the operation speed, and classify the sections using the converted audio signal.

As illustrated in FIG. 3A, the processor 120 may calculate a total time for each emotion type by classifying the sections of the audio signal according to the type of emotion of dialog. In addition, as illustrated in FIG. 3B, the processor 120 may calculate a total time for each atmosphere type by classifying the sections of the audio signal according to the type of atmosphere of background sound.

The processor 120 may generate first summary content by incorporating first sections representing a voice in an audio signal (S1030-1). In particular, the processor 120 may generate the first summary content based on the type of emotion of a first section. For example, when generating summary content of an action movie, the processor 120 may generate the first summary content using the section where emotion type is “surprised.” Here, the processor 120 may identify the type of content automatically, or identify the type of content according to a user input. The processor 120 may determine the priority of type of emotion based on the type of content, or may receive the priority of the type of emotion from a user.

The processor 120 may generate second summary content by incorporating second sections representing background sound in an audio signal (S1030-2). In particular, the processor 120 may generate the second summary content based on the type of atmosphere of a second section. For example when generating summary content of an action movie, the processor 120 may generate the second summary content using the section where atmosphere type is “urgent.” Here, the processor 120 may identify the type of content automatically, or identify the type of content according to a user input. The processor 120 may determine the priority of type of atmosphere based on the type of content, or may receive the priority of the type of atmosphere from a user.

The processor 120 may determine whether the playback time of the first summary content is less than a predetermined first time (S1040-1). If it is less than the predetermined first time, the processor 120 may band-pass filter the audio signal (S1041), and update the first summary content by extracting content as much as a sufficient time in the band-pass filtered audio signal (S1042). Here, the predetermined first time may be the playback time of the highlight that is determined according to the command to generate summary content.

For example, if the playback time of the first summary content is 5 minutes shorter than the predetermined first time, the processor 120 may band-pass filter the audio signal, and update the first summary content by extracting a content corresponding to 5 minutes from the band-pass filtered audio signal.

In this process, the processor 120 may graph extraction time information regarding a threshold value in the band-pass filtered audio signal. For example, as illustrated in FIG. 4B, the processor 120 may map a time obtained by collecting sections greater than threshold values Th1, Th3 in the band-pass filtered audio signal to a threshold value. In addition, the processor 120 may obtain a graph as shown in FIG. 4C by changing the threshold value to a predetermined unit. In other words, when an insufficient time is determined, the processor 120 may obtain a threshold value corresponding to the insufficient time in the graph as shown in FIG. 4C, and add sections equal to or greater than the threshold value in the graph as shown in FIG. 4B to the first summary content.

If the playback time of the first summary content exceeds the predetermined first time, the processor 120 may delete a part of at least one first section included in the first summary content (S1043). The deletion order may be determined at least one of the priority of the type of emotion and the playback time of each section. For example, the processor 120 may delete a plurality of first sections having a low priority of the emotion type in the order of the shortest playback time.

Meanwhile, the processor 120 may determine whether the playback time of the second summary content is less than the predetermined second time (S1040-2). If it is less than the predetermined second, the processor 120 may low-pass filter the audio signal (S1044), and update the second summary content by extracting a content corresponding to the insufficient time in the low-pass filtered audio signal (S1045). Here, the predetermined second time may be a playback time of dialog that is determined according to the command to generate summary content. Such an operation of the processor 120 is the same as the operation described above in the steps of S1041 and S1042 and thus, overlapping description will be omitted.

If the playback time of the second summary content exceeds the predetermined second time, the processor 120 may delete a part of at least one second section included in the second summary content (S1046). The deletion order may be determined based at least one of the priority of the type of atmosphere and the playback time of each section. For example, the processor 120 may delete a plurality of first sections having a low priority of the atmosphere type in the order of the shortest playback time.

Meanwhile, the processor 120 may generate the first summary content and the second summary content sequentially or simultaneously.

Subsequently, the processor 120 may incorporate the first summary content and the second summary content (S1050). The processor 120 may generate summary content by adjusting the entire playback time. For example, as illustrated in FIG. 5, the processor 120 may generate summary content to include an overlapping portion of the first summary content and the second summary content as one section.

In this case, the processor 120 may add some sections as the entire playback time is shortened. Here, the sections to be added may be one of the sections deleted in S1043 and S1046. Alternatively, the processor 120 may add sections based on the priority of the type of emotion and the priority of the type of atmosphere.

In addition, the processor 120 may add one of a voice section or a background sound section to summary content according to a user's preference. For example, if the user inputs the proportion of highlight as 90%, the processor 120 may add only the background sound section to the summary content.

Meanwhile, if there is no overlapping portion of the first summary content and the second summary content, the processor 120 may omit the step of S1060.

The processor 120 may generate summary content through the above-described method.

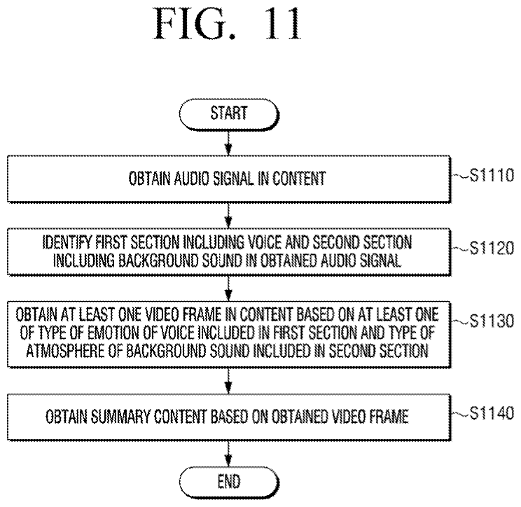

FIG. 11 is a flowchart provided to explain a control method of an electronic device according to an embodiment.

Firstly, an audio signal is obtained in a content (S1110). A first section including a voice and a second section including background sound are identified in the obtained audio signal (S1120). At least one video frame is obtained in the content based on at least one of the type of emotion of the voice included in the first section or the type of atmosphere of the background sound included in the second section (S1130). Subsequently, summary content is obtained based on the obtained video frame (S1140).

Here, the step of obtaining at least one video frame (S1130) may include obtaining at least one first video frame in at least one first section from among a plurality of first sections based on a priority of the type of emotion corresponding to each of the plurality of first sections and obtaining at least one second video frame in at least one second section from among a plurality of second sections based on a priority of the type of atmosphere corresponding to each of the plurality of second sections, and the step of obtaining summary content (S1140) may include obtaining first summary content based on the at least one video frame, obtaining second summary content based on the at least one second video frame, and obtaining summary content based on the first summary content and the second summary content.

The steps of, if the playback time of the first summary content is less than a predetermined first time, filtering an audio signal through a band-pass filter and adding a section that is equal to or greater than the predetermined first size in the band-pass filtered audio signal to the first summary content, and if the playback time of the second summary content is less than a predetermined second time, filtering the audio signal through a low-pass filter, and adding a section that is equal to or greater than the predetermined second size in the low-pass filtered audio signal to the second summary content may be further added.

The predetermined first size may be calculated based on a difference between the predetermined first time and the playback time of the first summary content, and the predetermined second size may be calculated based on a difference between the predetermined second time and the playback time of the second summary content.

Meanwhile, the steps of receiving information regarding the type and the playback time of summary content and calculating a predetermined first length and a predetermined second length based on the received information may be further included.

Meanwhile, the step of, if the playback time of the first summary content exceeds the predetermined first time, deleting at least a part of a plurality of first sections included in the first summary content based on the playback time of the plurality of first sections included in the first summary content may be further included.

Here, the step of obtaining summary content (S1140) may include, if there is an overlapping portion between the first summary content and the second summary content, obtaining summary content based on the playback time of the overlapping portion and the deleted first section.

Meanwhile, the step of obtaining an audio signal (S1110) may include converting at least one of a channel or a sampling rate of the audio signal, and obtaining at least one video frame based on the converted audio signal.

In addition, the step of displaying the obtained summary content may be further included.

According to the above-described various embodiments, by generating summary content based on the type of emotion of a voice and the type of atmosphere of background sound, an electronic device may provide summary content including important scenes that reflect a user's preference.

According to an embodiment, the above-described various embodiments may be implemented by software including instructions that are stored in machine-readable storage media (e.g., a computer). The machine is an apparatus that invokes the stored instructions from the storage media and is operable according to the invoked instructions, and may include the electronic apparatus (e.g., an electronic apparatus (A)) according to the disclosed embodiments. When the instructions are executed by a processor, the processor may perform functions corresponding to the instructions, either directly or using other components under the control of the processor. The instructions may include codes generated or executed by a compiler or an interpreter. The machine-readable storage media may be provided in the form of non-transitory storage media. Here, the term ‘non-transitory’ means that the storage medium does not include a signal and is tangible, but does not distinguish whether data is stored semi-permanently or temporarily in the storage medium.

According to an embodiment, the method according to diverse embodiments may be provided as being included in a computer program product. The computer program product may be traded as a product between a seller and a purchaser. The computer program product may be distributed in the form of a machine readable storage media (e.g., a compact disc read only memory (CD-ROM)), or online through an application store (e.g., PlayStore™). In the case of the online distribution, at least a portion of the computer program product may be at least temporarily stored in a storage medium such as a memory of a server of a manufacturer, a server of an application store, or a relay server, or be temporarily generated

In addition, the diverse embodiments described above may be implemented in a computer or an apparatus similar to the computer using software, hardware, or a combination of software and hardware. In some cases, embodiments described in the disclosure may be implemented by a processor itself. According to a software implementation, embodiments such as procedures and functions described in the specification may be implemented by separate software modules. Each of the software modules may perform one or more functions and operations described in the disclosure.

Meanwhile, computer instructions for performing processing operations according to the diverse embodiments of the disclosure described above may be stored in a non-transitory computer-readable medium. The computer instructions stored in the non-transitory computer-readable medium cause a specific device to perform the processing operations of the display apparatus according to the diverse embodiments described above when they are executed by a processor of the specific device. The non-transitory computer-readable medium is not a medium that stores data for a while, such as a register, a cache, a memory, or the like, but means a medium that semi-permanently stores data and is readable by the device. Specific examples of the non-transitory computer-readable medium may include a compact disk (CD), a digital versatile disk (DVD), a hard disk, a Blu-ray disk, a USB, a memory card, a ROM, and the like.

Each of the components (e.g., modules or programs) according to the diverse embodiments may include a single entity or a plurality of entities, and some sub-components of the sub-components described above may be omitted, or other sub-components may be further included in the diverse embodiments. Alternatively or additionally, some components (e.g., modules or programs) may be integrated into one entity to perform the same or similar functions performed by the respective components prior to the integration. The operations performed by the module, the program, or other component, in accordance with the diverse embodiments may be executed in a sequential, parallel, iterative, or heuristic manner, or at least some operations may be executed in a different order or omitted, or other operations may be added.

While preferred embodiments of the disclosure have been shown and described, the disclosure is not limited to the aforementioned specific embodiments, and it is apparent that various modifications can be made by those having ordinary skill in the art to which the disclosure belongs, without departing from the gist of the disclosure as claimed by the appended claims, and such modifications are not to be interpreted independently from the technical idea or prospect of the disclosure.

What is claimed is:

1. An electronic device, comprising:
a storage in which a content is stored; and
a processor configured to obtain an audio signal from the content, identify a first section including a voice and a second section including background sound from the obtained audio signal, obtain at least one video frame from the content based on at least one of a type of emotion of the voice included in the first section and a type of atmosphere of the background sound included in the second section, and obtain summary content based on the obtained video frame.

2. The electronic device as claimed in claim 1, wherein the processor is configured to obtain at least one first video frame from at least one first section from among a plurality of first sections based on a priority of an emotion type corresponding to each of the plurality of first sections, obtain at least one second video frame from at least one second section from among a plurality of second sections based on a priority of an atmosphere type corresponding to each of the plurality of second sections, obtain first summary content based on the at least one first video frame, and obtain second summary content based on the at least one second video frame.

3. The electronic device as claimed in claim 2, wherein the processor is configured to: based on a playback time of the first summary content being less than a predetermined first time, filter the audio signal through a band-pass filter, and add a section of which size is greater than a predetermined first size in the band-pass filtered audio signal to the first summary content, and
based on a playback time of the second summary content being less than a predetermined second time, filter the audio signal through a low-pass filter, and add a section of which size is greater than a predetermined second size in the low-pass filtered audio signal to the second summary content.

4. The electronic device as claimed in claim 3, wherein the predetermined first size is calculated based on a difference between the predetermined first time and the playback time of the first summary content, and
wherein the predetermined second size is calculated based on a difference between the predetermined second time and the playback time of the second summary content.

5. The electronic device as claimed in claim 3, further comprising:
a user interface,
wherein the processor is configured to receive information regarding a type and a playback time of the summary content through the user interface, and calculate the predetermined first time and the predetermined second time based on the received information.

6. The electronic device as claimed in claim 2, wherein the processor is configured to, based on a playback time of the first summary content exceeding a predetermined first time, delete at least part of a plurality of first sections included in the first summary content based on a playback time of the plurality of first sections included in the first summary content.

7. The electronic device as claimed in claim 6, wherein the processor is configured to, based on there being an overlapping portion between the first summary content and the second summary content, obtain the summary content based on a playback time of the overlapping portion and the deleted first section.

8. The electronic device as claimed in claim 1, wherein the processor is configured to convert at least one of a channel or a sampling rate of the audio signal, and obtain the at least one video frame based on the converted audio signal.

9. The electronic device as claimed in claim 1, further comprising:
a display,
wherein the processor is configured to display the obtained summary content through the display.

10. A controlling method of an electronic device, comprising:
obtaining an audio signal from a content;
identifying a first section including a voice and a second section including background sound from the obtained audio signal;
obtaining at least one video frame from the content based on at least one of a type of emotion of the voice included in the first section and a type of atmosphere of the background sound included in the second section; and
obtaining summary content based on the obtained video frame.

11. The method as claimed in claim 10, wherein the obtaining at least one video frame comprises:
obtaining at least one first video frame from at least one first section from among a plurality of first sections based on a priority of an emotion type corresponding to each of the plurality of first sections; and
obtaining at least one second video frame from at least one second section from among a plurality of second sections based on a priority of an atmosphere type corresponding to each of the plurality of second sections, wherein the obtaining summary content comprises obtaining first summary content based on the at least one first video frame, obtaining second summary content based on the at least one second video frame, and obtaining the summary content based on the first summary content and the second summary content.

12. The method as claimed in claim 11, further comprising:
based on a playback time of the first summary content being less than a predetermined first time, filtering the audio signal through a band-pass filter, and adding a section of which size is greater than a predetermined first size in the band-pass filtered audio signal to the first summary content; and
based on a playback time of the second summary content being less than a predetermined second time, filtering the audio signal through a low-pass filter, and adding a section of which size is greater than a predetermined second size in the low-pass filtered audio signal to the second summary content.

13. The method as claimed in claim 12, wherein the predetermined first size is calculated based on a difference between the predetermined first time and the playback time of the first summary content, and
wherein the predetermined second size is calculated based on a difference between the predetermined second time and the playback time of the second summary content.

14. The method as claimed in claim 12, further comprising:
receiving information regarding a type and a playback time of the summary content; and
calculating the predetermined first time and the predetermined second time based on the received information.

15. The method as claimed in claim 11, further comprising:
based on a playback time of the first summary content exceeding a predetermined first time, deleting at least part of a plurality of first sections included in the first summary content based on a playback time of the plurality of first sections included in the first summary content.
